(19) United States
(12) Patent Application Publication
(10) Pub. No.: US 2012/0025948 A1
(43) Pub. Date: Feb. 2, 2012

(54) POWER MANAGEMENT CIRCUITRY FOR ELECTRONIC DOOR LOCKS

(75) Inventors: Vijaya R. Lakamraju, Longmeadow, MA (US); John M. Milton-Benoit, West Suffield, CT (US); Ulf J. Jonsson, South Windsor, CT (US); Joseph Zacchio, Wethersfield, CT (US)

(73) Assignee: UTC FIRE AND SECURITY CORPORATION, Farmington, CT (US)

(21) Appl. No.: 13/263,243

(22) PCT Filed: Apr. 6, 2009
(86) PCT No.: PCT/US09/39631

§ 371 Date: Oct. 6, 2011

(51) Int. Cl. G06K 19/00

(52) U.S. Cl. 340/5.6

(57) ABSTRACT

A power management circuit decreases power consumption in an electronic door lock. The power management circuit includes an ON/OFF circuit, a load switch circuit and a electronic door lock circuit. The ON/OFF circuit generates an initial enable signal in response to a detected keycard that places the load switch circuit in an enabled state. When enabled, the load switch circuit provides dc power to the electronic door lock circuit that allows the electronic door lock circuit to receive identification input from the detected keycard and determine whether an output should be generated to actuate the door lock mechanism. Having completed the keycard detection operation, the electronic door lock circuit generates a self turn-off signal that is provided as feedback to the ON/OFF circuit to disable the load switch circuit. When disabled, the load switch circuit prevents any power from being provided to the electronic door lock circuit and thereby conserves energy otherwise consumed by the electronic door lock in times between activations.

### BACKGROUND

The present invention is directed to an electronic door lock circuit, and in particular to power management circuitry to minimize power consumption by the electronic door lock circuit.

Electronic door locks are employed in a variety of applications, providing both security and flexibility in controlling access. A well-known example is the magnetic strip electronic door lock employed by a majority of hotels.

Electronic door locks differ from traditional locksets, in which a key mechanically determines whether a door should be unlocked, in that electronic door locks include a microcontroller that receives identification data from a keycard (e.g., magnetic strip card, or radio-frequency identification (RFID) card) and generates an output that determines whether the door should be unlocked.

For electronic door locks connected to line power, power consumption is not of much concern. For electronic door locks that rely on an isolated power source, such as one or more batteries, then power consumption by the electronic door lock becomes an important factor in determining how long batteries will last before needing replacement. Electronic door locks that require frequent battery changes will increase the maintenance cost associated with the locks.

A variety of work has been done to minimize the power consumed by the electronic door lock during the activation stage, in which the door lock circuitry (typically a microcontroller) reads data from a keycard and electrically activates a mechanism to unlock the door. In the time between activation stages, the microcontroller is maintained in a sleep state that minimizes power consumption, while still allowing the processor to be alerted, generally through the use of interrupts, to the presence of a keycard.

While operating the microcontroller in a sleep mode improves power consumption, the microcontroller continues to draw small amounts of current that over time represent a significant portion of the available battery power.

### SUMMARY

A power management circuit is provided that conserves power for an electronic door lock system. The power management circuit includes an ON/OFF circuit, a load switch circuit and an electronic door lock circuit. The ON/Off circuit generates an enable signal in response to a detected keycard. The enable signal is provided to an enable pin of the load switch circuit. In response to a detected keycard, the load switch circuit is in an enabled state in which it provides power to the electronic door lock circuit. In response, the electronic door lock circuit reads identification data from the detected keycard and determines whether or not the door should be unlocked. Upon completing this task, the electronic door lock circuit generates a self turn-off signal that is provided in feedback to the ON/OFF circuit. In response, the enable signal provided to the load switch circuit is removed and the load switch circuit is disabled. In the disabled state, the load switch circuit prevents power from being provided (and therefore consumed) by the electronic door lock circuit.

### BRIEF DESCRIPTION OF THE DRAWINGS

FIG. 1 is a block diagram of a power management circuit for an electronic door lock according to an embodiment of the present invention.

FIGS. 2A and 2B are block diagrams illustrating other embodiments of the power management circuit for an electronic door lock according to the present invention.

### DETAILED DESCRIPTION

The present invention provides a power management circuit that reduces the power consumed by electronic door lock circuitry. In particular, the present invention focuses on reducing power requirements during the period in which the electronic door lock circuitry is inactive (i.e., the period between activations in which the circuitry is responsible for reading data from a keycard and actuating an unlocking mechanism that allows the door to be opened). The present invention takes advantage of low-power alternatives to sensing the presence of keycard that does not require intervention from the electronic door lock circuitry (typically a microcontroller). This allows the door lock circuitry to be turned ‘off’, as opposed to being placed in a partially active sleep state, in the periods of time between activations. This reduces the total amount of power consumed by the electronic door lock circuitry.

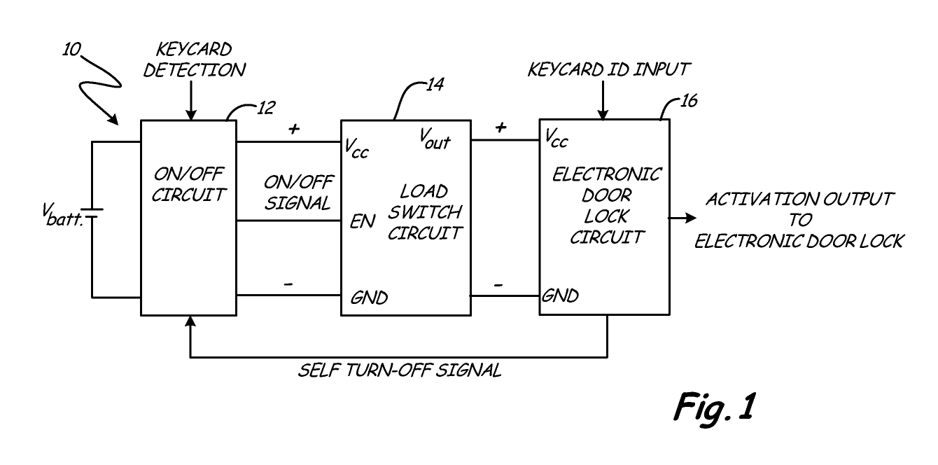

FIG. 1 is a block diagram of power management circuit 10 according to an embodiment of the present invention. Power management circuit 10 includes ON/OFF circuit 12, load switch circuit 14, and electronic door lock circuit (hereinafter, “lock circuit”) 16. A dc power source (e.g., a battery) labeled V_{batt} provides dc power to ON/OFF circuit 12 and load switch circuit 14. In some embodiments the dc power provided by V_{batt} may only be provided to load switch circuit 14 in response to the keycard detection input indicating the presence of a keycard. In this embodiment, however, the dc power provided by V_{batt} is also provided to load switch circuit 14.

Load switch circuit 14 is operated in one of two states, based on the input provided to the enable input “EN” of load switch 14. In the first state, load switch circuit 14 is enabled (e.g., the ON/OFF signal provided to the enable pin “EN” is a logic high value) and acts to supply the dc input voltage provided by the dc source or a modified version of the dc input voltage to lock circuit 16. In the second state, load switch circuit 14 is disabled (e.g., the ON/OFF signal provided to the enable pin “EN” is a logic low value) to prevent load switch circuit 14 from providing any dc power to lock circuit 16. As a result, lock circuit 16 does not consume power during inactive periods of time when no keycard is present. In addition, the quiescent current (current consumed by load switch circuit 14 in the disabled state) is extremely low, even as compared with the current consumed by prior art lock circuits that operate in a sleep state between activation periods. Therefore, during inactive periods, power management circuit 10, and in particular, load switch circuit 14 and lock circuit 16, consume very little power.

In response to load switch circuit 14 being enabled (i.e., first state), a dc output voltage is provided to power lock circuit 16. In one embodiment, lock circuit 16 may include a variety of components, such as a microcontroller, that are employed to electrically activate an unlocking mechanism in response to a matching keycard (represented by “keycard ID input”). The period of time in which lock circuit 16 responds to a presented keycard is referred to as the activation period. Following the activation period (e.g., unlock period, plus a relock period, plus a small duration of time between), lock circuit 16 generates a signal (labeled “End-of-Activation Signal”) that is provided as feedback to ON/OFF circuit 12. In response, ON/OFF circuit 12 disables load switch circuit 14 (i.e., second state), thereby removing all power from lock circuit 16. Power management circuit 10 remains in this low-power mode, in which lock circuit 16 consumes no power and load switch 14 consumes no or very little power, until a subsequent detection of a keycard.

The keycard detection input provided to ON/OFF circuit 12 may be electrical or mechanical nature. In one embodiment, a keycard (e.g., magnetic strip card) placed into the reader mechanically actuates a switch to generate the ON/OFF signal provided to load switch circuit 14. In this embodiment, the only power consumed by power management circuit 10 is related to the quiescent current, if any, consumed by a disabled load switch circuit 14 (i.e., in the second operational state). In another embodiment, a proximity sensor or similarly electrical sensor device is used to detect the presence of a nearby keycard. This is typically employed in embodiments in which the keycard is never actually swiped through a reader (no mechanical action), but only held in close proximity to the reader for reading. In this embodiment, a small amount of power must be diverted to the proximity sensor for detecting the presence of the keycard. The benefit of this approach, however, is the proximity sensor or similar device is typically a lower voltage device than the microcontroller employed by door lock circuit 16. Therefore, the power consumed by operating the low-voltage proximity sensor remains less than the power consumed by a traditional approach that requires the relatively higher voltage microcontroller (operating in a sleep mode) to be supplied with power.

Depending on the application and the type of keycard reader or sensor employed, load switch circuit 14 may provide power directly to a keycard reader or may provide power to electronic door lock circuit 16, which in turn provides power to the keycard reader. A benefit of providing power directly to the keycard reader following the enablement of load switch circuit 14, is the keycard reader is made operational very quickly following the detected keycard. In other embodiments however, electronic door lock circuit 16 provides power, based on the power received from load switch circuit 14, to the keycard reader. The benefit of this approach, is electronic door lock circuit may selectively remove power from the keycard reader upon receiving the ID data provided by the keycard, thereby conserving the total amount of power consumed by power management circuit 10.

In one embodiment, load switch 14 is implemented with a boost regulator that, when enabled, boosts the dc input voltage provided by V_{batt} to a higher voltage dc output. A benefit of this approach is a boost regulator is capable of being enabled and disabled the same as a load switch, and consumes very little power in the disabled state. In addition, a lower voltage dc power source, such as a single AA battery, may be employed despite higher voltage requirements from lock circuit 16. For instance, a dc input voltage generated by a single AA battery (approximately 1.2-1.5 Volts (V)) is converted by a boost regulator to a dc output voltage of approximately 2-5 V as required by a microcontroller employed by lock circuit 16. A benefit of employing the boost regulator is a lower voltage dc source (e.g., a single AA battery versus a higher voltage battery or several batteries connected in series to generate a higher voltage dc output) may be used in conjunction with devices, such as lock circuit 16, that require higher operational voltage levels to operate. In addition, the reduction of power consumed by the circuit during inactive periods extends the battery life associated with the dc power source. In other embodiments, the boost regulator may be implemented with other power conversion circuits, such as a buck regulator or a buck-boost regulator.

In an exemplary embodiment, the dc power source V_{batt} includes a plurality of individual batteries (e.g., AA batteries) connected in parallel to provide additional energy to power management circuit 10. In particular, this is useful in applications in which electronic door lock circuitry includes higher usage requirements. For example, for electronic door locks in which additional electrical energy is required to actuate the locking mechanism. In another embodiment, the dc power source V_{batt} includes a plurality of individual batteries connected in series with one another to provide a higher voltage dc input. This embodiment is useful in applications that do not employ a boost regulator, such that the voltage provided by dc source V_{batt} is sufficient to operate lock circuit 16 as well as any additional components.

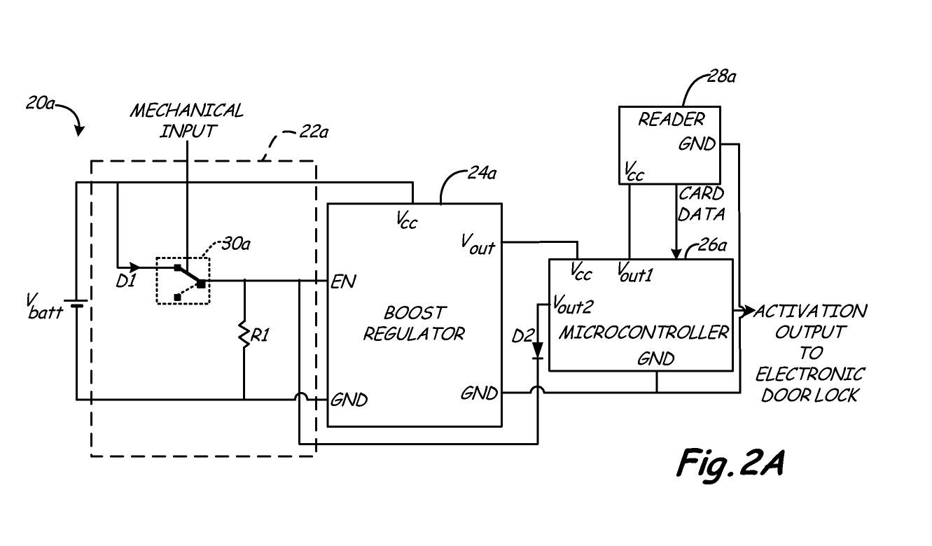

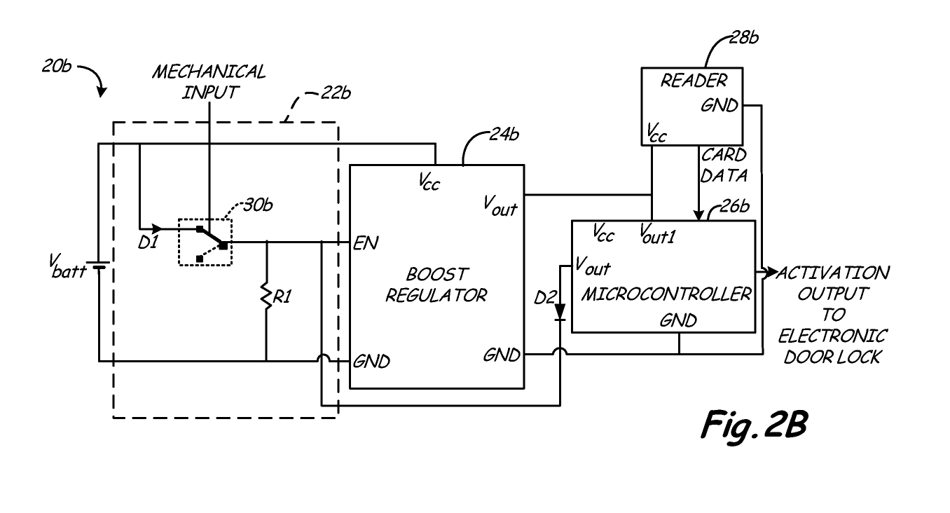

FIGS. 2A and 2B are block diagrams illustrating other embodiments of a power management circuit according to the present invention. The difference between the embodiments described with respect to FIGS. 2A and 2B is in how power is distributed to components included with the power management circuit.

FIG. 2A is a block diagram of power management circuit 20a that includes ON/OFF circuit 22a, boost regulator 24a, and microcontroller 26a. Reader 28a is included in this view to highlight the consequence of providing power sequentially from boost regulator 24a to microcontroller 26a, and from microcontroller 26a to reader 28a.

ON/OFF circuit 22a includes diode D1, mechanically activated switch 30a, and resistor R1. Dc power source V_{batt} is connected through diode D1 and switch 30a to the enable pin of boost regulator 24a. Switch 30a is maintained as an open circuit if no keycard is present within reader 28a (typically a slide-type magnetic reader), thereby preventing power from being supplied to the enable (EN) pin of boost regulator 24a. In response to the presence of a keycard, switch 30a is mechanically closed to supply power to the enable pin of boost regulator 24a, resulting in boost regulator transitioning from a disabled state to an enabled state.

In response to the enable signal provided by the activation of switch 30a, boost regulator 24a generates a dc output voltage (of higher voltage than the dc input voltage provided by V_{batt}) that is provided to microcontroller 26a. As microcontroller 26a becomes operational, one of the functions it performs is to provide a dc output (via output pin ‘Vout1’) to other components, such as reader 28a. In addition, microcontroller 26a provides a dc output (via output pin ‘Vout2’) that is provided as feedback to the enable pin of boost regulator 24a to ensure that after the keycard has been removed from reader 28a (causing switch 30a to open), boost regulator 24a will remain in the enabled state throughout the remainder of the activation period. Reader 28a provides microcontroller 26a with keycard ID data (labeled ‘ID Data’) that is employed by microcontroller 26a to determine whether the door should be unlocked. In response to matching ID data, microcontroller 26a generates an activation output that causes the door to be unlocked. Upon receiving complete ID data from reader 28a (but before the end of the activation period), microcontroller 26a may conserve power by removing power (provided via output pin Vout1) to reader 28a. In this way, the amount of power consumed by reader 28a is reduced, and additional power is conserved by power management circuit 20a.

At the end of the activation period, microcontroller 26a provides a self turn-off signal by removing the dc output previously provided in feedback to the enable pin of boost regulator 24a. In response, boost regulator 24a is disabled such that no dc power is provided to microcontroller 26a (or other passive components employed by the electronic door lock circuit). Power management circuit 20a remains in this state until a subsequent activation period is detected by the mechanical actuation of switch 30a. In this embodiment, resistor R2 is a pull-up resistor that prevents large currents from flowing into the enable pin of boost regulator 24a.

Benefits of this embodiment include extremely low power consumption in between activation periods. In particular, because ON/OFF circuit 22a is mechanically activated, keycard detection does not require any power consumption. Furthermore, as discussed above, boost regulator 24a consumes very little power when operating in the disabled mode, and microcontroller 26 and associated components associated with electronic door lock circuitry consume no power during non-activation periods.

In addition, microcontroller 26a may include storage capacity (e.g., random access memory, hardware registers, etc.) that allows the microcontroller, prior to generating the self turn-off signal, to store key variables associated with the operation of the electronic door lock. For example, the variables may be associated with the operating state of the microcontroller. In a subsequent activation, microcontroller 26a employs the stored variables to decrease the start-up time associated with the microcontroller and to improve the continuity associated with the microcontroller between subsequent activations.

FIG. 2B is a block diagram of power management circuit 20b that includes ON/OFF circuit 22b, boost regulator 24b, and microcontroller 16b. Power management circuit 20b operates in the same way as power management circuit 20a described with respect to FIG. 2A. The difference between the two embodiments is the manner in which the attached keycard reader receives power from the circuit.

In FIG. 2A, dc power provided by boost regulator 24a is provided to microcontroller 26a, with microcontroller 26a providing subsequent power to reader 28a. The benefit of this approach is microcontroller 26a is able to remove power to reader 28a immediately upon receiving ID data from the reader (as opposed to waiting for the end of the activation period). In this way, the amount of power consumed by reader 28a is minimized. However, this embodiment requires microcontroller 28a to, in essence, boot up before power is provided to reader 28a, adding additional time delays between the moment when the presence of the keycard mechanically closes switch 30a and the moment when reader 28a has received sufficient power from microcontroller 26a to read ID data from the keycard.

In the embodiment shown in FIG. 2B, dc power provided by boost regulator 24b is simultaneously provided to both microcontroller 26b and reader 28b. The benefit of this approach is reader 28b becomes operational more quickly because it does not require reader 26b to wait until microcontroller 26b is operational. However, the drawback of this approach is that microcontroller 26b cannot remove power to reader 28b upon receiving ID data. That is, reader 28b will remain active, and therefore will continue to consume power, until the activation period ends and the self turn-off signal provided in feedback by microcontroller 26b to the enable pin of boost regulator 24b causes power to be removed from both microcontroller 26b and reader 26b (as well as all other passive components).

Although the present invention has been described with reference to preferred embodiments, workers skilled in the art will recognize that changes may be made in form and detail without departing from the spirit and scope of the invention.

1. A power management circuit for an electronic door lock, the circuit comprising:
a ON/OFF circuit operably connected to generate an initial enable signal in response to a detected keycard;
a load switch circuit having an operating state determined by the initial enable signal, wherein in response to the initial enable signal representing a detected keycard the load switch circuit is enabled to provide a dc output voltage, wherein if no initial enable signal is present the load switch circuit is disabled such that no dc output voltage is provided; and
an electronic door lock circuit operably connected to receive dc power when the load switch circuit is enabled, wherein the electronic door lock circuit receives identification input from a keycard reader and generates in response an output that is provided to a locking mechanism, wherein in response to completing a keycard detection operation the electronic door lock circuit generates a turn-off signal that is provided in feedback to the ON/OFF circuit to disable the load switch circuit.

2. The power management circuit of claim 1, wherein the ON/OFF circuit includes a switch connected between a dc input and the load switch circuit, wherein the initial enable signal is generated in response to a keycard mechanically closing the switch such that the dc input is provided to enable the load switch circuit.

3. The power management circuit of claim 2, wherein the electronic door lock circuit, in response to receiving dc power from the load switch circuit provides an enable signal to the input of the load switch circuit to maintain the load switch circuit in the enabled state after the switch is opened in response to the keycard being removed, such that the load switch circuit is maintained in the enabled state until the electronic door lock circuit has completed the keycard detection operation and generated the turn-off signal.

4. The power management circuit of claim 3, wherein the turn-off signal is generated by modifying the enable signal from a logic high voltage to a logic low voltage such that the load switch circuit is disabled.

5. The power management circuit of claim 1, wherein the load switch circuit is a boost regulator circuit having an operating state determined by the initial enable signal, wherein in response to the initial enable signal representing a detected keycard the boost regulator circuit is enabled to boost a dc input voltage to provide a higher voltage dc output voltage, wherein if no initial enable signal is present the boost regulator circuit is disabled such that no dc output voltage is provided.

6. The power management circuit of claim 5, wherein the power management circuit consumes only a quiescent current associated with the boost regulator circuit when the boost regulator circuit is operating in a disabled state in which no dc output voltage is provided by the boost regulator circuit to the electronic door lock circuit.

7. The power management circuit of claim 1, wherein the load switch circuit provides, when enabled, a dc output voltage to a keycard reader.

8. The power management circuit of claim 1, wherein the electronic door lock circuit provides, based on power received from the load switch circuit, dc power to a keycard reader that is selectively removed in response to identification data being received from the keycard reader.

9. The power management circuit of claim 1, wherein the electronic door lock circuit includes a microcontroller connected to receive dc power when the load switch circuit is enabled, and consume no power when the load switch circuit is disabled.

10. A method for managing power consumption for a electronic door lock, the method comprising:
operating an electronic door lock circuit in a no-power mode in which a load switch circuit is disabled to prevent power from being supplied to the electronic door lock circuit;
detecting a keycard while the electronic door lock circuit remains in the no-power mode;
enabling the load switch circuit to supply power to the electronic door lock circuit in response to the detected keycard;
determining whether the electronic door lock should be unlocked based on data retrieved from the keycard; and
generating a self turn-off signal that is provided as feedback by the electronic door lock circuit to disable the load switch circuit and return the electronic door lock to the no-power mode.

11. The method of claim 10, wherein detecting the keycard includes:
closing a switch in response to mechanical actuation provided by the keycard entering a reader such that a dc power source is provided to an enable pin of the load switch circuit to enable the load switch circuit.

12. The method of claim 10, wherein supplying power to the electronic door lock circuit further includes:
applying a dc output provided by the electronic door lock circuit in feedback to the enable pin of the load switch circuit to maintain the load switch circuit in the enabled state during the determination of whether the electronic door lock should be unlocked.

13. The method of claim 10, wherein supplying power to the electronic door lock circuit further includes:
boosting a dc input provided by the dc power source to a higher voltage dc output to be supplied to the electronic door lock circuit.

14. The method of claim 10, wherein the load switch circuit supplies power to a keycard reader in response to a detected keycard.

15. The method of claim 10, wherein the electronic door lock circuit supplies power, to a keycard reader based on power supplied by the load switch circuit.

16. The method of claim 15, further including selectively removing power from the keycard reader subsequent to receiving data retrieved from the keycard but prior to generating the self turn-off signal.

17. An electronic door lock comprising:
a keycard reader for accepting a keycard and reading data stored on the accepted keycard;
a switch located in the keycard reader that is closed in response to a keycard placed in the keycard reader;
a load switch circuit having an operating state determined by a signal applied to an enable pin of the load switch circuit, wherein a detected keycard results in a dc input being communicated through the closed switch to the enable pin to enable the load switch circuit, wherein the load switch provides a dc output when in the enabled state and no output when in a disable state; and
an microcontroller connected to receive dc power from the enabled load switch circuit, wherein the microcontroller provides a dc output to the enable pin of the load switch circuit to maintain the load switch circuit in an enabled state after the keycard has been removed from the keycard reader, wherein the microcontroller receives identification input from the keycard reader and generates in response an output that is provided to a locking mechanism, wherein in response to completing a keycard detection operation the microcontroller generates a self turn-off signal by removing the dc output provided to the enable pin of the load switch circuit to disable the load switch circuit and remove subsequent power from the microcontroller.

18. The electronic door lock of claim 17, wherein the load switch circuit is a boost regulator circuit that boosts a dc input to a higher voltage dc output when enabled and provides no dc output when disabled.

19. The electronic door lock of claim 18, wherein the dc power received by the microcontroller is a higher voltage than the dc input provided to the boost regulator.

20. The electronic door lock of claim 19, wherein the dc input provided to the boost regulator is equal to the voltage provided by a single AA battery.

21. The electronic door lock of claim 17, wherein the keycard reader is connected to receive power from the microcontroller, wherein subsequent to receiving identification input form the keycard reader but prior to generating the self-turn off signal, the microcontroller removes power from the keycard reader.

22. The electronic door lock of claim 17, wherein the keycard reader is connected to receive power from the enabled load switch circuit.

23. The electronic door lock of claim 17, wherein the microcontroller includes storage capacity for storing key variables prior to generating the self turn-off signal, the key variables employed during subsequent activations of the microcontroller.
